(19) United States
(12) Patent Application Publication
(10) Pub. No.: US 2007/0122599 A1
(43) Pub. Date: May 31, 2007

(54) Food storage wrap

(75) Inventor: Brian D. Furlong, Davidson, NC (US)

Correspondence Address: LEMPIA FORMAN LLC, 223 W. JACKSON BLVD., SUITE 620, CHICAGO, IL, 60606, US

(73) Assignee: Rubbermaid Incorporated, Huntersville, NC (US)

(21) Appl. No.: 11/555,944

(22) Filed: Nov. 2, 2006

Related U.S. Application Data
(60) Provisional application No. 60/732,736, filed on Nov. 2, 2005.

(51) Int. Cl. B32B 7/02

(52) U.S. Cl. 428/212; 428/220

(57) ABSTRACT

A food wrap has a flexible carrier sheet and a prep panel structure connected to the carrier sheet. The prep panel structure is made from a material that is less flexible than the carrier sheet and has two prep sections. A closure feature is incorporated as a part of the wrap. The wrap can be configured to a folded condition to completely surround a food article. At least parts of the flexible carrier sheet overlap other parts of the carrier sheet in the folded condition and the food article is sandwiched between the two prep sections. The closure feature assists in maintaining the wrap in the folded condition.

### RELATED APPLICATION DATA

This patent is related to and claims priority benefit of prior filed U.S. Provisional Application Ser. No. 60/732,736, which was filed on Nov. 2, 2005, and was entitled “Reconfigurable Food Storage Wrap,” the entirety of which is incorporated herein by reference.

### BACKGROUND OF THE INVENTION

1. Field of the Disclosure

The present disclosure is generally directed to food storage articles, and more particularly to a wrap product that can be used to store food items.

2. Description of Related Art

Conventional storage articles are known for storing food items and the like, and are typically either of a substantially rigid plastic configuration, thin film cling or foil sheet configuration, or a flexible bag configuration. Plastic containers of this type typically have a base and a lid. The base has a bottom and a side wall that defines a storage space. The lid snaps onto the base to seal the storage space. The lid and base of this type of plastic container typically remain in the same configuration at all times.

Thin film sheet materials typically come in rolls of sheet material that can be separated into individual wrap products. Plastic film sheet is commonly of the self-cling variety where the material can be folded unto itself and will cling to itself until being physically unwrapped or separated. Thin metal foil sheet is typically very bendable and capable of retain whatever shape into which it is bent.

Bag type storage containers are typically made of paper or a flexible, transparent, plastic material. These types of bags have a storage space within wall panels of the bag. Some bags have only two non-pleaded panels that are connected to one another along three sides, leaving an opening on a fourth side and forming a square or rectangular flat configuration. Some bags have pleats and more than two side panels and are formed so that the bag can expand between the two larger, primary side walls to create a greater volume and/or to hold larger objects than can not fit in a simple, two-panel, non-pleated bag.

All of these types of common storage products are utilized to store food items. In one example, people use these types of products to store their lunch, which often can include a sandwich. Many people prepare their lunch at home and then carry their lunch to their work place or to school for consumption later in the day. There are a few prescribed steps that most people generally follow when preparing their lunchtime sandwich. One step is to clear a prep surface to keep the sandwich fixings and the work space clean while preparing their sandwich and other lunch items. Another step is to prepare the sandwich and other lunch items on the prep surface. A further step is to then place their sandwich and perhaps other lunch items in either a rigid plastic container, one or more thin wrap sheets, or in a flexible sandwich or lunch bag. The sandwich and other lunch items are then placed in another container, such as a lunch box, briefcase, purse, plastic bag, brown paper bag, or other soft-sided container. Then, of course, the sandwich is removed along with the other lunch items and consumed later in the day away from the home environment. The typical empty storage container is then either thrown away or transported back home to be re-used.

One problem with conventional rigid plastic containers is that the containers must be carried back home. The container takes up as much space whether traveling to or from work or school, even though there is typically nothing left in the container on the return trip. The container then is cleaned and reused another time. The flexible bag type container offers virtually no protection for the food stored in the container from contact with other items. Often the food item, such as a sandwich, can become squished or damaged during transport or other activities prior to the lunch or food items being consumed. Similar problems are common for thin metal foil or plastic cling wraps. These thin wrap sheets can be used as a food prep surface, but are not durable enough to withstand any type of contact with food prep tools such as knives. A rigid plastic container offers projection to the food items but is not typically disposable and, thus, is transported to and from different locations for use. The soft-sided storage bags or thin wrap materials typically offer no physical protection for the food items. Additionally, none of these products offers any type of durable food preparation surface or space that can be used to prepare the food items that will be transported in the containers. The user must first free up a space on a table or countertop and clean off that surface prior to food preparation.

### BRIEF DESCRIPTION OF THE DRAWINGS

Objects, features, and advantages of the present invention will become apparent upon reading the following description in conjunction with the drawing figures, in which:

FIG. 1 shows an exploded view of one example of a food storage wrap constructed in accordance with the teachings of the present invention.

FIG. 2 shows an exploded view of another example of a food storage wrap constructed in accordance with the teachings of the present invention.

FIGS. 3A and 3B show perspective views of two alternative examples of a closure feature for a food storage wrap such as those shown in FIGS. 1 and 2.

FIG. 4 shows a top plan view of an assembled, unfolded food storage wrap as shown in either of FIG. 1 or 2.

FIGS. 5-10 show a plurality of different food storage wrap examples each constructed in accordance with the teachings of the present invention.

FIGS. 11A-11G show the sequential steps of preparing and wrapping a food item in a food storage wrap such as those shown in FIGS. 1-4.

FIGS. 12A-12F show the plurality of sequential steps to unwrap the food storage wrap shown in FIGS. 11A-11G in order to access the stored food item.

### DETAILED DESCRIPTION OF THE DISCLOSURE

Various examples of food storage wraps are disclosed herein that solve or improve upon one or more of the above-noted and other problems and disadvantages with prior art food storage products. The disclosed food storage wraps can be configured to offer a food preparation surface when unfolded. The disclosed wraps also can offer some physical protection during transport and storage of the food contained within the wrap. The disclosed wraps also can offer an eating surface after re-opening the wrap while the food is being consumed. The disclosed wraps also are conveniently disposable after use. The disclosed wraps also can be configured to include one or more closure features that assist in securing the wrap around a food item held within the wrap.

Turning now to the drawings, FIG. 1 shows an exploded view of one example of a food storage wrap 20 constructed in accordance with the teachings of the present invention. In general, the food storage wrap 20 has a primary base or carrier sheet 22, which has a rectangular configuration in this example. As will become evident upon reading this disclosure, the sheet need not be rectangular, but instead can be square, oval, have rounded corners, have non-linear edges, or the like. The carrier sheet 22 can also be varied in size according to a desired food preparation and storage application. In one example, the disclosed wrap 20 can be particularly sized and configured to wrap and completely enclose a fairly common food item such as a sandwich. The following description is provided using a sandwich as the food item example. However, the invention is clearly not intended to be limited only to wraps configured to store sandwiches.

In the disclosed example, the carrier sheet 22 has a pair of side edges 24 that define a length of the rectangular carrier sheet 22. The carrier sheet 22 also has a pair of end edges 26 that define a width of the carrier sheet. The carrier sheet can be constructed from any suitable, flexible material. In one example, the carrier sheet can be made from a thin film plastic sheet that has at least some degree of cling properties so that the material easily and readily clings or sticks to itself when folded. Also, the plastic material of the carrier sheet 22 can be clear or transparent or can at least be translucent, if it is desired to see the food item stored in the wrap. In another example, the plastic material can be provided in different colored thin film sheet material, whether opaque or transparent.

In one example, the plastic carrier sheet material can be a polyethylene (PE). However, the carrier sheet can be formed from other suitable materials as well. For example, a thin metal foil material can be used for the carrier sheet material. Such materials can be bent and retain their shape, which can assist in the sheet staying wrapped around a food item. In other examples, the carrier sheet 22 can be formed from paper products including recycled paper, coated paper, and readily sustainable paper products such as sugar cane or potato based paper products.

The wrap 20 also includes a prep panel 30 that is carried on the carrier sheet 22. The prep panel 30 in this example is formed as a laminate structure from materials that result in a structure that is less flexible than the carrier sheet. In the disclosed example, the prep panel 30 has two generally flat prep sections 32a and 32b that are longitudinally aligned with one another relative to the length of the carrier sheet 22. Each disclosed prep section 32a, 32b is generally a square shape (with rounded corners) and has one edge 34 spaced from but adjacent to the similar edge 34 of the other prep section. In this example, an intermediate strip 36 is positioned between the edges 34 of the prep sections 32a, 32b and is interconnected along a joint to each of those edges. In one example, the joint between the edges 34 of the prep sections 32a, 32b and the intermediate strip 36 can be scored, formed with intermittent gaps, or formed as a frangible connection to facilitate folding for purposes as described below.

The prep panel 30, or at least the prep sections 32a, 32b as shown in this example, can be formed with at least their exposed surfaces formed from a food-safe material. In an alternate example, or in combination with the food-safe characteristics, the prep sections 32a, 32b or the entire prep panel 30, can be formed with the exposed surfaces having non-stick characteristics such as a wax paper finish or the like. As shown in FIG. 1, the prep sections 32a, 32b are formed as a laminate structure in this example. The laminate structure in this example has a food contacting layer 38 and two structural layers 40a and 40b. In this example, the food contacting layer 38 includes the exposed surfaces of the prep sections 32a, 32b and the entire intermediate strip 36. The structural layers 40a and 40b in this example are provided in two parts, each shaped only to match one of the two prep sections 32a, 32b. Each of these layers 40a, 40b is formed from a material that is sturdier than the carrier sheet 22, and in one example, sturdier than the food contacting layer 38. Both the food contacting layer and structural layers in this example can be a single unitary sheet (like layer 38) or formed in multiple separate parts (like layers 40a, 40b) as desired. The structural layers 40a and 40b can be formed from any suitable material, but in one example can be formed from a cardboard or paperboard material having a relatively thin gauge. The food contacting layer 38 can be formed from a food safe, non-stick paper that is also substantially thin.

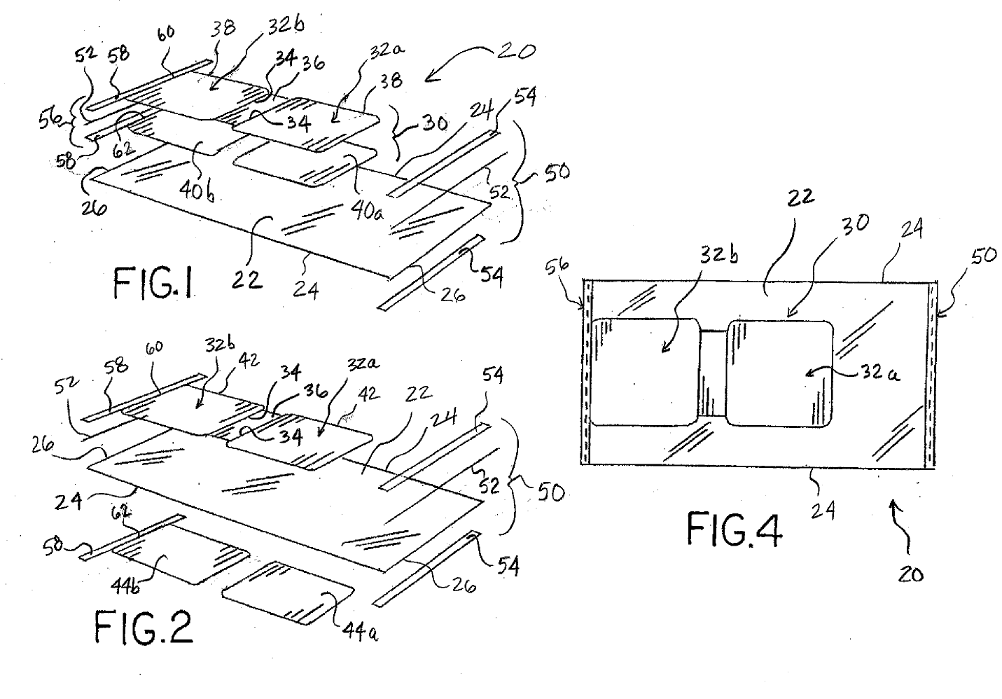

In the disclosed example, the layers 40a, 40b and 38 are adhered to one another on the same side of the carrier sheet 22. As shown in FIG. 2, the prep panel 30, if formed as a laminate structure, can alternatively have one or more food contacting layers 42 on one side of the carrier sheet 22 and one or more structural layers 44a, 44b adhered to the carrier sheet on the opposite side so that the carrier sheet 22 is between the layers 42 and 44a, 44b. In another example (not shown), the prep panel 30 can be formed of a single material layer that provides some structural characteristics as well as the food prep, food-safe, and/or non-stick characteristics intended for a particular application.

In this example, the prep panel 30 is configured having a slightly hourglass shape with each of the two prep sections 32a, 32b having a first width and the intermediate strip having a width slightly less than the prep sections. The structural layers 40a, 40b and 44a, 44b in these examples lie positionally aligned with a respective one of the food layers 38 and 42, whether lying directly against the food layer or with the carrier sheet 22 positioned between the two layers. Also as shown in FIG. 1, the intermediate strip 36 in each example is integral with only the food contacting layers 38 or 42. However, in other examples, the intermediate strip 36 can be a part of only the structural layers or have essentially the same material construction as the entirety of the prep sections 32a, 32b. Thus, the entire prep panel 30 can have the same structure, whether it is a laminate or a unitary single layer. In other alternatives, the structural layers 40a, 40b and 44a, 44b can be eliminated in the disclosed examples, or can be fabricated from different materials to provide particular performance characteristics. For example, the structural layers 40a, 40b and 44a, 44b can be provided from a thin, rigid plastic layer that is laminated to either a food contacting layer or to the carrier sheet 22 opposing the food contacting layer on the other side of the sheet.

Also, the prep panel 30 and/or its various layers or surfaces can be adhered to the carrier sheet 22 using any suitable adhesive, material, or process. In one example, the prep panel 30 is simply adhered to a surface of the carrier sheet 22 using a suitable adhesive carried on one or more of the surfaces of the various parts of the wrap structure, depending on the construction and configuration of the wrap 20.

Also as shown in FIGS. 1, 2, 3A, and 3B, the disclosed wrap can have a closure feature or mechanism incorporated as a part of the wrap 20. The closure feature can take on different configurations and employ various devices to perform one or more of the intended functions as discussed below. In addition, the closure features can incorporate a combination of two or more different mechanisms. In one example, as shown in FIG. 1, the closure feature is a twist tie that is attached along one or both of the end edges 26 of the carrier sheet 22. One twist tie 50 includes a thin gauge wire 52 sandwiched between two layers of food safe, non-stick paper or plastic film 54. In this example, the material of the carrier sheet 22 at the one end edge 26 is also captured between the paper layers 54 and the paper layers are adhered to the carrier sheet 22. Thus, the twist tie 50 is provided as a part of the carrier sheet 22. As shown in FIG. 1, one of the closure features, such as a twist tie, can be provided as an integral part of a portion of the prep panel 30. In this example, a twist tie 56 is formed by elongate paper strips 58, one of which is integral with an edge 60 opposite the edge 34 of the left most prep section 32b of the food layer 38, and the other of which is integral with the corresponding edge 62 of the structural layer 40b in this example. A thin gauge wire 52 is sandwiched between the two thin strips 58 forming the twist tie 56 as an integral part of the left most prep section 32b of the prep panel 30 in this example.

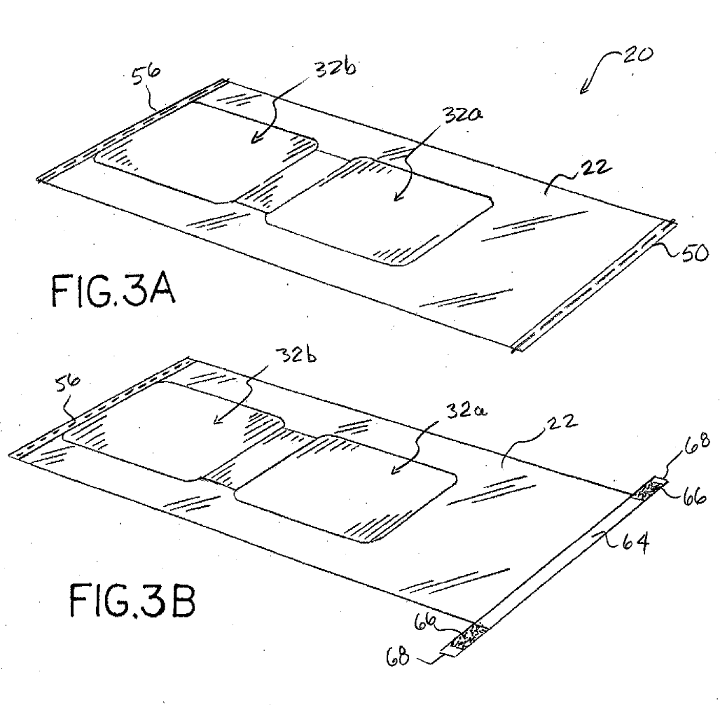

FIG. 3A shows a perspective view of the food wrap 20 of FIG. 1 with the twist ties 50 and 56 as the closure features. FIG. 3B shows essentially to same food wrap structure, but having at least one of the closure features constructed according to a different example of the present invention. In this example the twist tie 50 has been replaced by an adhesive strip 64 with reusable adhesive patches 66 on the distal ends 68 of the strip. In this example, the distal ends 68 extend outward beyond the side edges 24 of the carrier sheet 22. The strip 64 can be paper or thin plastic as well, and can impart some stiffness. The strip can also be a single layer of material or can be a dual layer structure similar to the twist ties. Clearly, the twist tie 56 can also be replaced by an alternate closure feature, such as a paper strip 64 with adhesive patches 66.

In each of these disclosed closure feature examples, the closure features assist in retaining the wrap 20 around a food product during use. This helps in keeping the food product fresh while it is stored in the wrap. In another example, the closure features can alternatively, or in addition to the twist ties or papers strips, be created by the dinginess of the material of the carrier sheet 22 to itself. Thin film plastic materials are known for food preparation purposes that employ a pressure sensitive characteristic as a part of the exterior surface of the sheet. Conventional plastic wraps also have substantial dinginess so that the material sticks to itself when folded onto itself around a food product. The cling nature of the carrier sheet 22 can be incorporated as the sole closure feature or in combination with one or more additional closure features, such as the twist tie or the self adhesive paper strip arrangements described herein. Some thin film plastic sheets are completely clear or transparent and the material can and will readily stick to itself when one portion of the sheet comes in contact with another portion of the sheet. Other types of thin film sheets may require the application of some pressure to a surface of the sheet when in contact with another part of the sheet, whereby the pressure creates adhesion between the two surfaces of the sheet. As will be evident to those having ordinary skill in the art, the particular material used to fabricate the carrier sheets disclosed herein can vary considerably and yet fall within the spirit and scope of the present invention. The degree of dinginess and the manner in which it can be achieved in the wrap can also vary.

The size, particular configuration, and placement of the prep panel 30 on the carrier sheet 22 can also vary and yet fall within the spirit and scope of the present invention. FIG. 4 illustrates a plan view of the wrap 20 shown in FIG. 1. In this example, the prep panel 30 is positioned at a midpoint between the two side edges 24 of the carrier sheet 22 and is offset lengthwise adjacent one of the end edges 26. Thus, in this example the closure feature or twist tie 56 is aligned with and positioned on that end edge 26 of the carrier sheet. However, as will be evident to those having ordinary skill in the art, other arrangements of the prep panel 30 and the carrier sheet 22 are possible and yet will fall within the spirit and scope of the present invention. Additionally, other optional features can be added to the wrap 20 to make the wrap easier for a consumer to use.

For example, FIG. 5 is a plan view of one alternative food storage wrap 120. In this example, the wrap is essentially the same configuration as that shown in FIGS. 1-4. However, a release tab 122 projects outward from the closure feature on the remote end edge 26. The release tab 122 in this example can be provided to assist the user to unwrap a food product stored within the wrap 120 during use. Also in this example, the closure features are each a twist tie 50 and 56 as in the previous example. FIG. 6 shows a wrap 130 that utilizes twist tie closure features 50 and 56. A release tab 132 extends outward from an edge of the twist tie 56 connected to an edge of the prep panel 30 in this example. Otherwise the wrap 130 is the same as the wrap 120.

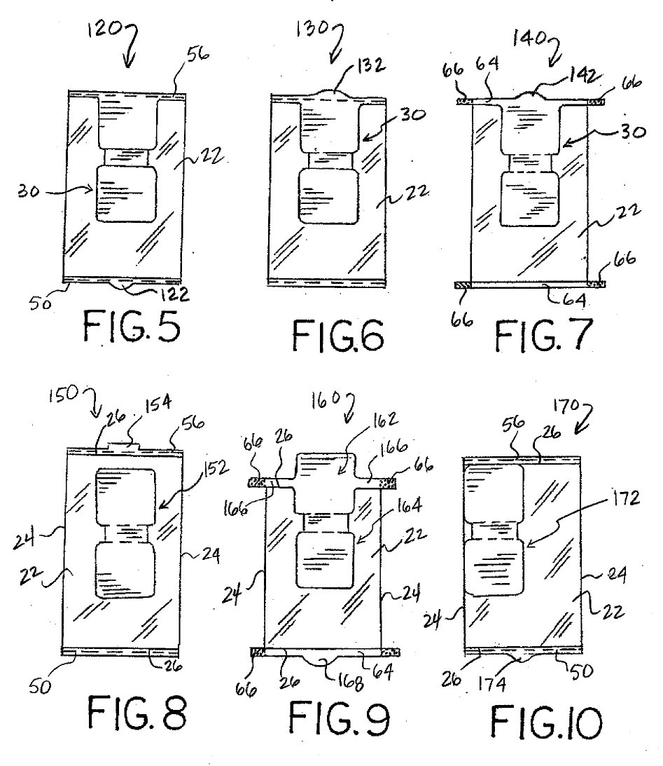

FIG. 7 is a plan view of a wrap 140 that is essentially identical to the wrap 130 except that both of the closure features are pressure sensitive adhesive strips 64. In this example, the wrap 140 has a release tab 142 on one of the strips 64 also coupled to an edge of the prep panel 30. In each of the alternative examples in FIGS. 5-7, the prep panel is positioned essentially in the same location as the prep panel 30 of the previously described wraps 20.

As discussed above, the prep panel structure 30 can be altered relative to the carrier sheet and yet fall within the spirit and scope of the present invention. For example, FIG. 8 is a wrap 150 with a prep panel 152 positioned spaced from each of the side and end edges 24 and 26 on the carrier sheet 22. Thus, a portion of the carrier sheet is exposed on all sides of the prep panel structure in this example. The wrap 150 also includes a release tab 154 carried on one of the closure features. The closure features are both twist ties 50 in this example, each separately attached to an end edge 26 of the carrier sheet and not connected to a portion of the prep panel 152.

FIG. 9 is another possible alternative example of a wrap 160 wherein a portion of one of the prep sections 162 of a prep panel 164 extends beyond an end 26 of the carrier sheet 22. In this example, a pair of strips 166 project laterally outward from the overhanging prep section 162 beyond the side edges 24 of the sheet 22. These extended strips 166 each include a reusable adhesive patch 66 to assist in securing the wrap 160 around a food product. A paper strip 64 is connected to the opposite end edge 26 of the carrier sheet and has pressure sensitive adhesive patches as previously described. As will be evident to those having ordinary skill in the art, the closure feature in this example also can be replaced by twist tie structures or other suitable features. The paper strips 64 on the remote edge 26 of the carrier sheet 22 also have a release tab 168 in this example.

FIG. 10 is yet another example of a wrap 170 constructed in accordance with the teachings of the present invention. In this example, a prep panel 172 is positioned adjacent one of the side edges 24 and adjacent one of the end edges 26 of the carrier sheet 22. In this example, the prep panel structure is lengthwise oriented corresponding to the length of the carrier street. As will be evident to those having ordinary skill in the art, it is possible for a prep panel structure in any of the disclosed embodiments to be oriented with its lengthwise dimension rotated 90° relative to the length dimension of the carrier sheet 22 and yet function as intended. In this example, each of the end edges 26 of the carrier sheet 22 includes a twist tie 50 and 56 providing closure features for the wrap 170. The twist tie 50 has a release tab 174 in this example. As will also be evident to those having ordinary skill in the art, the cling characteristics of the sheet 22 can be a closure feature in each of the above-described alternative examples, either instead of or in combination with the twist ties, pressure sensitive strips, or other closure devices.

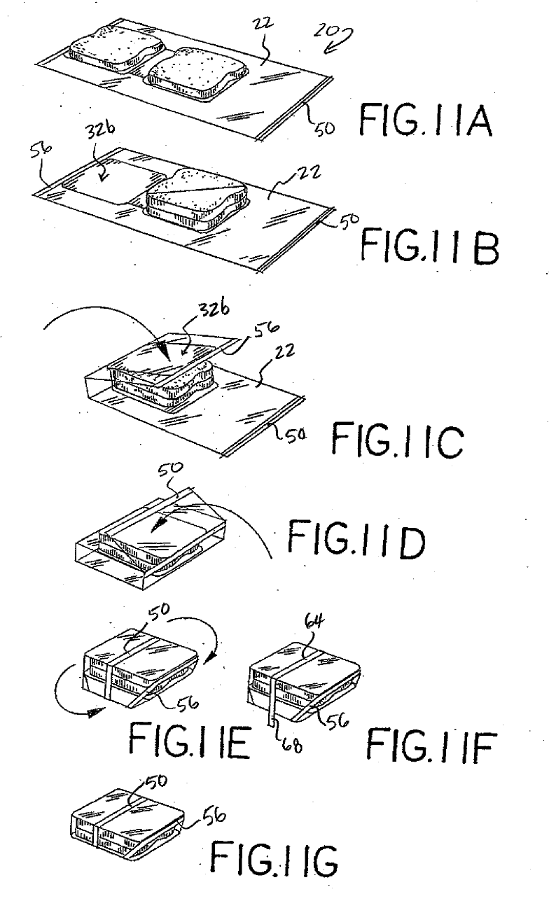

FIGS. 11A-11G are a series of illustrations depicting one example of how the disclosed wraps can be utilized step-by-step to prepare, wrap, and store a food item. In this example, the use of the wraps 20 is described in conjunction with the preparation and storage of a conventional sandwich. As shown in FIG. 11A, the wrap 20 is laid open on a surface and a piece of bread is placed on each of the food-safe exposed surfaces of the prep sections 32a and 32b. The user can then prepare the sandwich as they normally would and even cut the sandwich in two once prepared, as shown in FIG. 11B. The completed sandwich can then be placed on the central most prep section 32a in preparation for wrapping the sandwich with the wrap 20. Using the wrap 20 for food preparation creates a ready-made food preparation surface, eliminates the need for the user to dirty other dishes or countertop surfaces to prepare the food, and keeps the work surface clean, which can speed up the food preparation process.

Once the sandwich is prepared, the wrap can be folded around the sandwich. As shown in FIG. 11C, the exposed prep section 32b can be folded about the intermediate strip 36 and the scored or otherwise perforate edges 34 to lie on top of the sandwich. As shown in FIG. 11D, the other end of the sheet 22 can then be folded on top of the back side of the prep section 32b and overlap or overlie the carrier sheet 22. As shown in FIGS. 11E (twist ties) and 11F (adhesive strips), depending upon the type of closure feature is utilized, the side edges 24 of the carrier sheet 22 that extend outward beyond the sandwich can then be folded down onto the sides of the sandwich. As shown in FIG. 11G, the side edges 24 of the sheet 22 can then be wrapped underneath the sandwich. Then the closure features, whether they be twist ties 50 and 56, pressure sensitive adhesive strips 64, and/or the cling characteristics of the carrier sheet 22, can be bent or otherwise positioned and pressed to retain the wrap 20 folded around the sandwich as shown in this figure.

The stored sandwich shown in FIG. 11A-11G is then ready for placement in another container such as a lunch bag, a lunch box, a brief case, a purse, or the like and is ready for transport. The sandwich is well protected by the surfaces of the prep panel 30 that surround it. The closure features, including any cling characteristics of the thin film sheet 22, will hold the overlapping portions of the carrier sheet 22 in place while the sandwich is stored and transported. The wrap 20 thus provides a tightly sealed storage space for the sandwich or other type of food item that will help keep the food item fresh until consumed.

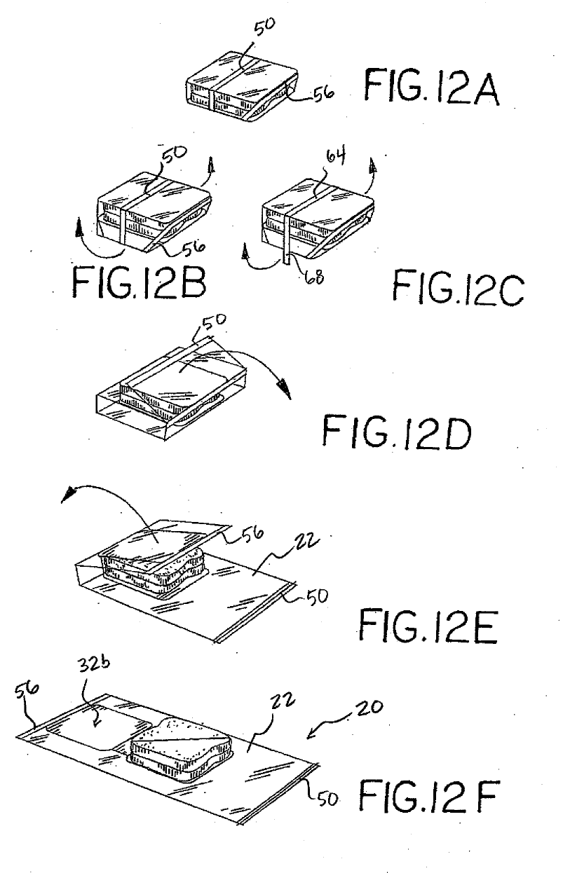

FIGS. 12A-12F show the steps that are used to expose the sandwich for consumption. The wrapped sandwich is illustrated in FIG. 12A. The user first can release the closure features from underneath the sandwich by either separating the pressure sensitive adhesive (FIG. 12C) and/or the surfaces of the carrier sheet 22 clung together, or by releasing the twist ties 50 and 56 (FIG. 12B). Upon doing so, the side edges 24 of the carrier sheet 22 can then be raised upward exposing the sides of the sandwich.

As shown in FIG. 12D, the free end of the carrier strip 22 can be released from the top of the sandwich. Then the prep panel 30, including the prep section 32b on top of the sandwich, can be unfolded exposing the top of the sandwich as shown in FIG. 12E. Upon completion of the unfolding process, the wrap is laid open and completely flat and the sandwich is exposed for consumption as shown in FIG. 12F. The food-safe nature of the prep sections 32a and 32b provide a sanitary eating surface on which a user can consume their food. Additionally, use of the wrap 20 during food consumption keeps the underlying surface clean so that no clean up will be required after the food is eaten.

The various examples of food storage wraps disclosed herein can be manufactured using any suitable process. In one of numerous possible examples, the cling wrap or thin film sheet material can be continuously extruded or otherwise let out. The prep panel structures can also be continuously formed, cut, laminated, unrolled, let out, and/or extruded in a separate process. The sheet and prep panel layer can be fabricated simultaneously and adjacent to one another, if desired, so that the prep panel material strip and the thin film material strip of the carrier sheet can be laminated, adhered, or otherwise attached to one another in a continuous process. The continuous laminate strip of wraps can then either be cut into individual wraps and laid in piles for packaging or can be left in a continuous strip. Such a continuous strip can be formed with spaced apart perforate or frangible tear lines in the strip material to segregate and define each of the wraps. Such a perforate strip of wraps can then be rolled and packaged for the consumer. The consumer can pull the strip from a package and tear off individual wraps as needed. Clearly, other processes can also be utilized to fabricate the disclosed wraps and yet fall within the spirit and scope of the present invention.

As noted above, the prep panel surfaces and the prep panel structures can vary in size and configuration to accommodate different sized and shaped food items. The disclosed wrap configurations and constructions are described to accommodate a sandwich. However, other food items can also be accommodated in the design of the wrap products. For example, a circular prep panel configuration with scored edges that can fold upon one other can be created to form a shell or dish in conjunction with a thin film sheet. The structure can be folded similar to the wraps disclosed and described herein to produce an on-the-go container for storing miscellaneous food items such as fruit slices, chips, or the like. Structural layers of the disclosed prep panels can also be configured, if desired, to fold up around a specific type of food item to provide specific crush protection. A folded structural panel can be configured to fold up and form structural side panels oriented perpendicular to the primary top and bottom prep section layers. The intermediate strip 36 described herein offers one example of such a panel that can be oriented differently than the primary prep sections 32a and 32b of the disclosed prep panel structure.

The disclosed food storage wraps 20, 120, 130, 140, 150, 160, and 170 each provide a single product that can be used by consumers to prepare, store, transport, and consume a food item that is prepared at one time in the day, perhaps transported to a different location, and consumed later in the day. The wraps are conveniently disposable and inexpensive to manufacture. The wraps can provide essentially the same advantages as a known storage bag or plastic container and yet are easier to fill and unwrap. The disclosed wraps, when storing food, can take on nearly the exact shape of food item, similar to many storage bags. Additionally, the structural nature of the disclosed prep panels provides a degree of crush protection similar to a rigid storage container and yet avoids the disadvantages of storing and transporting food in a rigid container.

The various closure features described herein provide at least two functions. First, the examples disclosed herein securely hold the wrap in the in-use or folded storage configuration. This can enhance keeping the food fresh and keeping the wraps secured around the food item for continued crush protection until the food is consumed. Second, the twist ties, adhesive strips, and other closure features can also be formed having some structural rigidity. The various disclosed strips can help manage the cling film carrier sheet 22 and keep it in a flat form during food preparation and food consumption. The relatively stiff or structural nature of these types of closure features can inhibit the film from clinging to itself and assist in holding the ends of the wrap in the flat condition.

The various disclosed wraps also help to reduce the number of food preparation steps. There would be no need to use and dirty extras dishes because the wraps themselves provide the food preparation surface. The disclosed wraps also offer many of the advantages of both food storage bags and plastic storage containers. The wraps described herein are disposable and offer significant space efficiency, just as food storage bags provide. The disclosed wraps also provide crush protection for the stored food items, just as rigid plastic storage containers provide. The disclosed wraps also offer improved functionality over conventional, known, cling film wrap products currently on the market today. The disclosed wraps offer better value and more convenience than such plastic wraps products. The addition of the prep panel 30 assists in holding the wrap in the unfolded condition for food preparation and consumption and provides crush resistance. The prep panel structures also provide a food preparation surface and a food consumption surface that stays flat and resists cutting. Conventional known wrap products do not offer such advantages.

Conventional food storage bags are often considered to have advantages over rigid plastic food storage containers. A bag can be configured to a very compact size and shape when not in use. A bag can also conform to nearly the size and shape of any stored contents when in use, thus taking up potentially less space for storing a food product. Consumers also feel that a bag is truly disposable. The disclosed wraps of the invention offer these very same advantages. Rigid containers retain the same size and shape whether in use or not. Rigid containers take up the space no matter the size or shape of any stored contents. Even if a rigid container is intended to be disposed of, consumers often do not do so and instead retain the container unnecessarily. Consumers often do not like to transport empty rigid containers back home for reuse, but feel obligated to do so. These disadvantages of rigid containers are avoided in the disclosed food storage wraps of the invention.

Rigid food storage containers are often considered to offer at least one big advantage over food storage bags. The access opening to the storage space of a rigid container is relatively large and typically retains its shape for the user when filling the container with a food product. Flexible storage bags are often difficult for a user to fill because of their flexible structure and the lack of a consistent size and shape opening into the bag. When filling a conventional food storage bag, a user must often hold the bag upright or open with one hand, leaving only hand free to fill the bag. This can be particularly difficult when transferring contents to a food storage bag from a heavy or large pot or other cooking vessel. Some pleated food storage bags may function somewhat more similarly to a brown paper grocery bag. This feature may in some instances help the storage bag to stay open while being filled. However, the pleated storage bag does not help to create a large, stable, rigid opening to facilitate dispensing or filling the bag. As soon as the bag is tilted for dispensing, or as soon as contents hit the flexible side walls of the bag, the opening can close or change significantly in size and shape. This can make filling and dispensing even a pleated bag rather difficult. Rigid containers alleviate these concerns. The disclosed wraps are fully unwrapped when being filled and thus eliminate the filling problems of conventional storage bags and achieve the crush resistance benefit of the rigid container. The disclosed wraps also offer the above-noted advantages over conventional food wrap products.

Rigid storage containers offer physical, structural protection for food items stored in a container. The disclosed wraps can be fabricated to offer at least some degree of physical protection for the stored food items. This feature can be enhanced or minimized, depending on the particular structure and materials used to create the prep panel structures 30, 152, 162, and 172 disclosed herein.

As mentioned above, food storage bags and conventional cling wrap material have an advantage over rigid food storage containers in that they are typically disposable after one or only a few uses. Consumers typically have no problem disposing of these types of food storage products. Although there are several types of disposable, “semi-rigid” food storage containers formed having a thin-wall structure, these are otherwise still viewed as a more durable, rigid, reusable container. Such disposable “semi-rigid” containers take up just as much space in a waste container as when they are in use. Thus, consumer will often choose to clean and reuse these types of containers instead of throwing them away. Through interviews with consumers, these factors combine to make many consumers uncomfortable with throwing away “disposable” semi-rigid food storage containers, which are commonly in use today. Because consumers are less likely to clean bags and wraps and because they take up little space in the garbage, consumers feel bags are more suited to one-time usage. The disclosed wraps are fully disposable and are much more similar to conventional cling wrap sheet material and storage bags because they do not have a true rigid nature. Thus, a consumer typically will have no problem disposing of the disclosed wraps after use.

Although certain food storage wraps have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A food wrap comprising:
a flexible carrier sheet having a perimeter with two side edges defining a sheet width and two end edges defining a sheet length;
a prep panel structure that is less flexible than the carrier sheet and carried by the carrier sheet, the prep panel structure having two generally flat prep sections and being spaced from at least one of the side edges and at least one of the end edges of the carrier sheet; and
a closure feature incorporated as part of the wrap,
wherein the wrap can be reconfigured to a folded condition to completely surround a food article, wherein at least parts of the flexible carrier sheet overlap other parts of the carrier sheet and the food article is sandwiched between the two prep sections, and wherein the closure feature assists in maintaining the wrap in the folded condition.

2. A food wrap according to claim 1, wherein the carrier sheet is formed from a thin film cling wrap material that clings to itself.

3. A food wrap according to claim 2, wherein the wrap closure feature is at least partly provided by the cling characteristics of the thin film cling wrap material.

4. A food wrap according to claim 1, wherein the perimeter of the flexible carrier is rectangular in shape.

5. A food wrap according to claim 1, wherein at least part of the prep panel is fabricated from a food-safe material that is thicker and sturdier than the carrier sheet.

6. A food wrap according to claim 1, wherein at least part of the prep panel is fabricated from a material with non-stick surface characteristics.

7. A food wrap according to claim 1, wherein the two prep sections of the prep panel are fabricated as dual-layer structures each having a food contact layer and a structural layer.

8. A food wrap according to claim 7, wherein the food contact layer is a thin paper layer and the structural layer is a thin gauge cardboard or paperboard layer.

9. A food wrap according to claim 8, wherein the paper layer of each prep section is adhered to one side of the carrier sheet and the cardboard or paperboard layer of each prep section is adhered to the opposite side of the carrier sheet and is aligned with a respective one of the paper layers.

10. A food wrap according to claim 8, wherein the paper layer of each prep section is adhered to one side of a respective one or the cardboard or paperboard layers to form two laminate prep sections, and wherein an opposite side of the cardboard or paperboard layers are adhered to the carrier sheet.

11. A food wrap according to claim 1, wherein the carrier sheet is formed from a thin metal foil sheet and wherein the wrap closure feature is at least partly provided by the bending characteristics of the thin metal foil sheet material.

12. A food wrap according to claim 1, wherein the prep sections are connected to one another by an intermediate strip of material formed of the same material as at least part of the two prep sections.

13. A food wrap according to claim 1, wherein the closure feature is a twist tie and is attached to part of the carrier sheet near the perimeter.

14. A food wrap according to claim 1, wherein the closure feature is a paper strip attached along one of the edges of the carrier sheet, wherein at least parts of the paper strip include an exposed pressure sensitive adhesive that can adhere to the carrier sheet.

15. A food wrap according to claim 14, wherein opposite end sections of the paper strip extend outward beyond the perimeter of the carrier sheet and wherein the pressure sensitive adhesive is at least on the opposite end sections.

16. A flexible food wrap comprising:
a carrier sheet;
a prep panel structure connected to the carrier sheet and that is less flexible than the carrier sheet, the prep panel having two prep sections and a strip of material positioned between and connected to each of the two prep sections along fold lines; and
a closure strip carried near an edge of the carrier sheet,
wherein the wrap can be folded to completely surround a food article sandwiched between and in contact with the two prep sections, and wherein the closure strip assists to retain the wrap folded and surrounding the food article.

17. A flexible food wrap according to claim 16, wherein the closure strip is a bendable wire twist tie attached along an edge of the carrier sheet.

18. A flexible food wrap according to claim 16, wherein the closure strip is a paper strip attached along an edge of the carrier sheet and has a patch of an exposed pressure sensitive adhesive material on each end of the strip that can adhere to the carrier sheet.

19. A flexible food wrap according to claim 16, wherein the carrier sheet is formed from a cling wrap material that can cling to itself.

20. A flexible food wrap according to claim 16, wherein the prep panel is formed having a first paper layer with non-stick characteristics and a second cardboard or paperboard layer.
